(19) United States
(12) Patent Application Publication
(10) Pub. No.: US 2014/0328651 A1
(43) Pub. Date: Nov. 6, 2014

(54) Membrane Lift Assembly

(71) Applicant: Banner Environmental Engineering Consultants Ltd., Black Diamond (CA)

(72) Inventors: Jeremy Huet, Black Diamond (CA); James Marr, Black Diamond (CA)

(73) Assignee: Banner Environmental Engineering Consultants Ltd., Black Diamond (CA)

(21) Appl. No.: 14/200,704

(22) Filed: Mar. 7, 2014

Related U.S. Application Data
(60) Provisional application No. 61/774,848, filed on Mar. 8, 2013.

(51) Int. Cl. C02F 3/12

(52) U.S. Cl. CPC C02F 3/1273
USPC 414/222.01

(57) ABSTRACT

The present application provides a lift assembly for a portable, modular wastewater treatment facility, the lift assembly capable of inserting and/or removing a membrane from a membrane bioreactor. The lift assembly is self contained reducing the user to exposure to environmental elements.

### FIELD OF THE INVENTION

The present application pertains to the field of water and wastewater treatment. More particularly, the present application relates to a lift assembly for the replacement of membranes in a modular membrane bioreactor plant.

### BACKGROUND

In wastewater treatment facilities, the process to generate potable or non-potable effluent involves a complex series of steps to ensure proper removal of biological waste and minimize downstream effects on the environment. Recently, membrane bioreactors have been used to maximize the removal of contaminants from the effluent. In a typical membrane bioreactor, a semi-permeable membrane is used to filter particulate matter from wastewater, and allowing effluent comprising cleaner wastewater to pass therethrough.

Membrane bioreactors are particularly useful in remote settings where portable wastewater treatment facilities exist. U.S. Pat. No. 8,287,733 to Juergen, describes an exemplary membrane bioreactor. The reduced footprint, modular design (usually transported to a location within a container or shack suitable for transport by truck or rail), and extremely high quality treated effluent, are important attributes, especially within environmentally sensitive areas. However, membrane bioreactors have their challenges in extreme weather conditions, particularly in the Arctic and other areas with very cold temperatures. Membranes are generally intolerant to freezing and, if frozen, they can become permanently ruined. Membranes are both expensive, hard to replace and are a long lead order item.

There exist numerous problems with current industry standard membrane replacement, cleaning and inspection systems. Membranes are typically replaced and inspected manually as needed, usually every 6-12 months depending upon the membrane. In harsher climates, it can render it extremely dangerous to the worker entrusted with removing and replacing the membrane and very expensive if membranes are inadvertently frozen. Typically, a worker mounts the top of the container carrying the membrane bioreactor and manually, or with a third party crane or picker truck, lifts the membrane out of position before replacing it with a fresh membrane. In extreme cold conditions, the worker may experience a risk of frostbite or worse. In many designs the worker may have to climb into the membrane tank to disconnect the membrane mounting and/or piping exposing the worker to a biohazard (i.e., untreated wastewater) and potential noxious gases. Also, a worker may be injured from falling off the roof the container, particularly if it is covered in snow and/or ice, or in high winds. Often, additional fall protection and confined space procedures are required to facilitate membrane replacement. Freezing of the membranes will result in expensive and time sensitive replacement which could include the potential for environmental violations for remote locations where truck service is not readily available.

Therefore, there exists a need for a means to replace a membrane from a portable, modular wastewater treatment facility that reduces the risk and exposure of dangerous conditions to the user.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a membrane bioreactor replacement system.

In accordance with an aspect of the present invention, there is provided a lift assembly for a portable, modular wastewater treatment facility, the lift assembly capable of inserting and/or removing a membrane from a membrane bioreactor. The lift assembly comprises one or more extendable arms or columns for raising and/or lowering the lift assembly to a first position to a second position, and one or more crossbeams connecting the one or more arms for attaching the membrane thereto.

Optionally, the lift assembly comprises a cover integral or attached to the crossbeam, a slidable track or trolley on the crossbeam for laterally movement of the membrane, and/or a tarp for covering the lift assembly.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 shows a lift assembly within a portable, modular wastewater treatment facility as described herein;

FIG. 2 shows the lift assembly in the retracted position;

FIG. 3 shows the lift assembly in the extended position.

### DETAILED DESCRIPTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

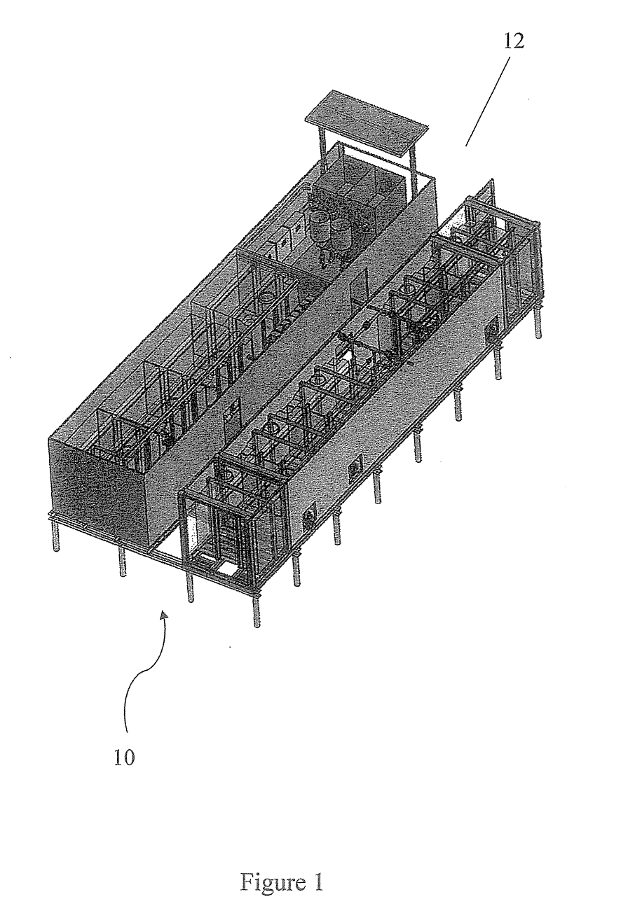

As shown in FIG. 1, the lift assembly can be used with a water or wastewater filtration system, such as but not limited to a treatment facility container 10 housing a portable wastewater treatment facility. In certain embodiments, the lift assembly is used for replacing membranes in a membrane bioreactor 12, such as in a modular wastewater treatment facility. While a membrane bioreactor will be mentioned herein as one possible wastewater filtration system for use with the present lift assembly, it is contemplated that other filtration systems may similarly be used with the present lift assembly, including those that have a membrane or other filtering devices that require insertion and/or removal.

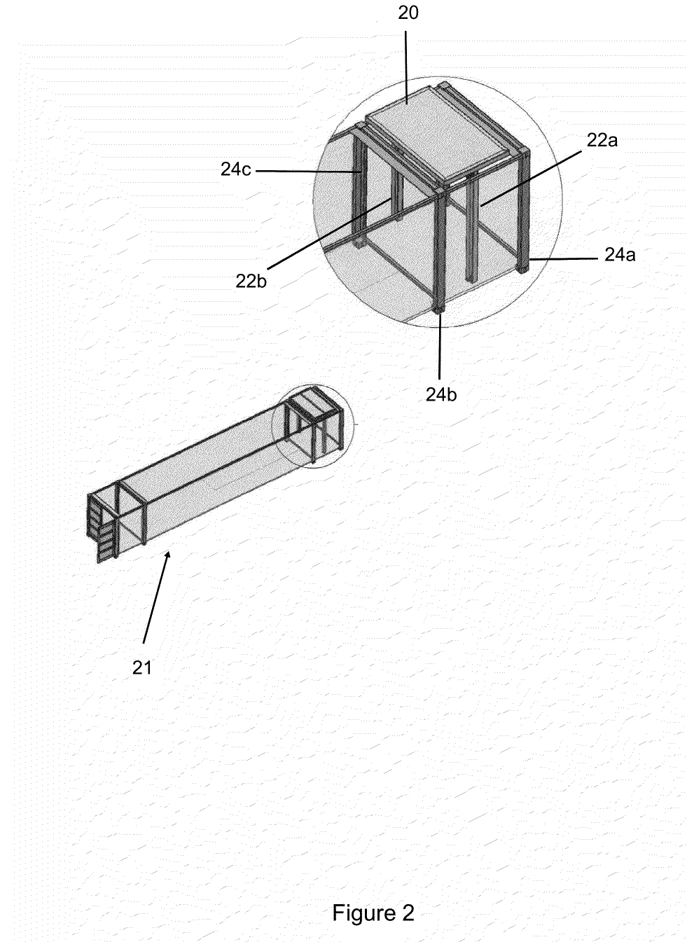

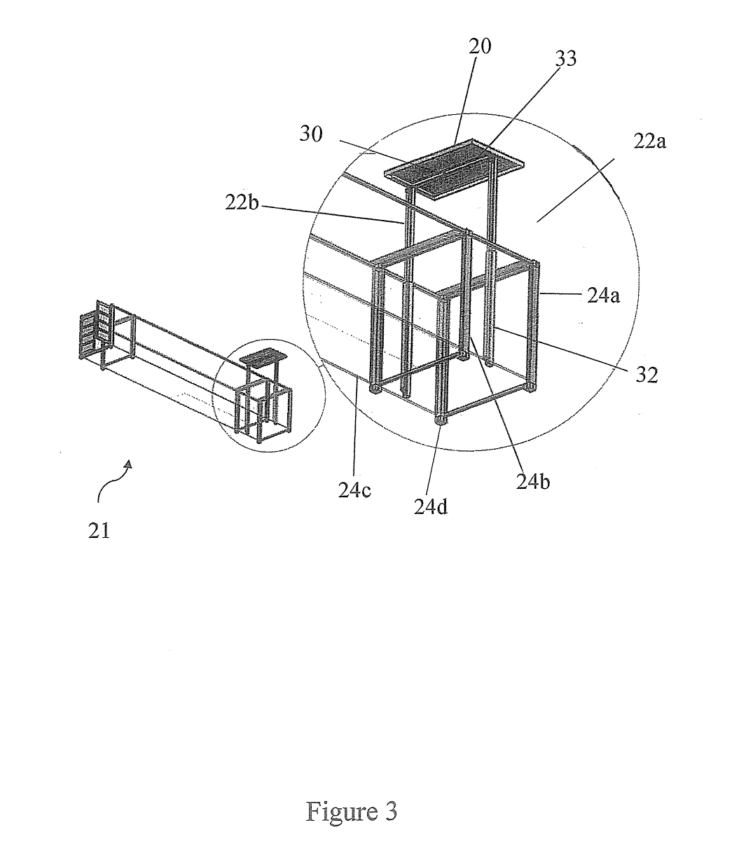

As best shown in FIGS. 2 and 3, the lift assembly as described herein comprises one or more, typically two, extendible arms 22a and 22b. The membrane bioreactor (not shown) is framed with posts 24a, 24b and 24c (a fourth post not shown) within a container 21. The arms 22a, 22b are made of a durable material, such as steel, to lift and lower a membrane (not shown) between different positions. The arms can be slidable along a guide post 32, but can also be telescoping within a cylinder or other similar arrangement. Ideally, the arms should be able to extend freely between positions while maintaining stability to retain the membrane attached thereto.

The arms are movable from a first, lower (or retracted) position to a second, raised (or extended) position. In the lower, retracted position, the membrane is inserted into (or to be removed from) the bioreactor. The arms are connected by a crossbeam 33. The crossbeam 33 should be of a similar durable material as the arms, to accommodate different sizes and weights of membranes. Typical membranes for use in membrane bioreactors as described herein are in the 100-200 kg range, but it will be contemplated that membranes of other sizes may be used.

A cover 20 can optionally be added to protect the bioreactor and the user. As best shown in FIG. 2, the cover spans the width of the lift from one arm to the other. The crossbeam 33 may be attached or otherwise integrated with the cover. The cover is designed to protect the user and the membrane bioreactor therebeneath from the harsh environmental elements (such as those found in Arctic climates, for example, where portable, modular water filtration systems are commonly used). Optionally, a tarp (not shown) can be added to the lift assembly to drape from the cover down one or more, typically four, sides of the lift assembly. The tarp can be made of any solid, durable material, which is suitable to add more coverage to the user as well as to the bioreactor.

In use, the lift assembly is positioned above the membrane bioreactor. The arms are extendably engageable with one or more guides which direct the arms upward or downward. For example, the arms can be slidably engaging with the guides. The arms are controlled by any suitable means, such as a mechanical (e.g., crank shaft), hydraulic or cable driven. An operator engages the controlling means for causing the lift assembly to move from one position to another position. In certain embodiments where a membrane is to be removed from the bioreactor, the bioreactor can be initially drained to remove the wastewater. The membrane can then be aerated and washed with bleach to kill and remove any pathogens. This step can reduce the risk of exposure to any contaminants to the user. Then, the operator attaches the membrane to the crossbeam connecting the two arms. The membrane can be connected using a chain, wire, or other durable member suitable for hoisting the membrane and maintaining it attached to the crossbeam without having it become disengaged.

Once attached to the lift assembly, the membrane is raised from the bioreactor. The arms are activated causing them to extend within the sleeve and/or against the guide post(s). The membrane is removed and placed outside the bioreactor. A new membrane is then attached to the crossbeam and is hoisted into position. When the membrane is positioned above the bioreactor, the arms are activated causing them to retract within the sleeve and/or against the guide post(s). The new membrane is then lowered into the bioreactor, and connected to the wastewater delivery system. The membrane can be disengaged from the crossbeam, and the bioreactor is sealed. A chain hoist or winch could alternatively be used from the extended position to remove the membrane from the lift assembly.

Optionally, a pulley or track system 30 can be added to the crossbeam. This connects to the chain which engages the membrane, and facilitates lateral movement of the membrane from above the bioreactor to another location. For example, the membrane once hoisted can be moved adjacent to the bioreactor to assist the user in replacing the membrane at ground level (i.e., without the need to enter the bioreactor).

The lift assembly as described herein provides means to change membranes for use in membrane bioreactors in portable, modular wastewater treatment facilities, such as those shipping containers typically used in remote locations. Advantageously, the lift assembly of the present invention eliminates safety hazards as typically encountered with current membrane bioreactor systems. For example, there is no need to mount the roof of a container comprising the membrane bioreactor to open hatches is eliminated, reducing the risk of a fall off the roof or stairs caused by high winds or icy conditions. In this way, a user can be positioned inside the container and protected from the elements. The lift assembly removes the membrane from the bioreactor without the need to physically enter and service the bioreactor, which can expose the user to harmful biohazards.

Further, there is eliminated the necessity to double stack the containers. This is typically done to house other hoist mechanisms. However, only one container reduces transportation costs, reducing the need to ship and stack two units and eliminates any height restrictions that may be in place.

All publications, patents and patent applications mentioned in this Specification are indicative of the level of skill of those skilled in the art to which this invention pertains and are herein incorporated by reference to the same extent as if each individual publication, patent, or patent applications was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

The embodiments of the invention in which an exclusive property or privilege is claimed are defined as follows:

1. A lift assembly for a modular wastewater treatment facility, wherein the lift assembly inserts or removes a membrane from a membrane bioreactor.

2. The lift assembly of claim 1, comprising: one or more extendably engaging arms for raising or lowering the lift assembly from a first position to a second position, and one or more crossbeams connecting the one or more arms for attaching the membrane thereto.

3. The lift assembly of claim 2, wherein the first position is within the membrane bioreactor and the second position is outside of the membrane bioreactor.

4. The lift assembly of claim 1, further comprising a cover integral or attached to the crossbeam.

5. The lift assembly of claim 1, further comprising a slidable track or trolley on the crossbeam for laterally movement of the membrane.

6. The lift assembly of claim 1, further comprising a tarp for covering the lift assembly.

7. A lift assembly for a modular wastewater treatment facility, comprising one or more extendably engaging arms for raising and/or lowering the lift assembly from a first position to a second position, one or more crossbeams connecting the one or more arms for attaching the membrane thereto and a slidable track or trolley on the crossbeam for laterally movement of the membrane.
